(19) United States
(12) Patent Application Publication
(10) Pub. No.: US 2024/0370749 A1
(43) Pub. Date: Nov. 7, 2024

(54) INFERENCE WITH STRICT CONDITIONALS USING REFLEXIVE MODEL

(71) Applicant: Raytheon Company, Walthum, MA (US)

(72) Inventors: Joshua A. Binkley, Richardson, TX (US); Christine R. Nezda, Richardson, TX (US)

(21) Appl. No.: 18/142,899

(22) Filed: May 3, 2023

(51) Int. Cl. G06N 7/01

(52) U.S. Cl. CPC G06N 7/01

(57) ABSTRACT

Embodiments regard a system for inference and corresponding action. A method includes receiving, from one or more sensors, measurements of evidence of existence of an event of interest, providing, to a model that operates using a type-2 probability and encodes probabilistic rules, the measurements of the evidence, providing, by the model and responsive to the measurements of the evidence, an output indicating a likelihood the event of interest exists, and altering, based on a communication from an operator, an object in a geographical region of the event of interest.

### TECHNICAL FIELD

Embodiments provide for improved probabilistic inference on events of interest from indicators in the absence of priors (for application in unseen environments). Embodiments leverage subject matter expert knowledge on positive and negative correlations between indicators and events rather than requiring prior probabilities that indicators or events should occur in an environment.

### BACKGROUND

The nation faces many challenging and unprecedented problems. For example, evolving enemy tactics within varying geographical, political, and logistical contexts make establishing relevant norms or baselines from which they can usefully assess and predict behavior extremely challenging. Systems for behavior prediction often rely on probabilistic priors that encode exactly this kind of information to the best possible human or machine ability. However, the mismatch between the data involved in constructing these priors, and the reality of the new situations in which they are deployed, can result in significant error in machine inference, loss of usability, and risk to those looking to prevent or counteract the behavior.

Prior target presence predictors include the requirement of operator-provided priors. The operator-provided priors, in new situations, may be completely unavailable. If they are available, they are likely to come with low confidence, and as a result, inferences about events of interest would also have low confidence. Related work in fuzzy logic faces an issue with material implication as in first order logic. Related work in subjective logic produces multiple outputs, avoiding production of a single numeric output that can be used in conjunction with a threshold by the operator. In other words, the operator is required to make decisions in light of multiple probability masses, and using existing technology today would still likely be required to provide priors on the indicators and/or events of interest (in the form of base rates). Similarly, methods leveraging AI techniques require extensive training data drawn from the target environment, or a reasonable representation of the target environment which, like probabilistic priors, may be unavailable or very low confidence.

### BRIEF DESCRIPTION OF THE DRAWINGS

FIG. 1 illustrates, by way of example, a diagram of an embodiment of a system for improved event inference.

FIG. 2 illustrates, by way of example, a diagram of an embodiment of a system that includes a model, generated by the system of FIG. 1, in operation.

FIG. 3 illustrates, by way of example, a diagram of an embodiment of a method for decision and action.

FIG. 4 illustrates, by way of example, a block diagram of an embodiment of a machine in the example form of a computer system within which instructions, for causing the machine to perform any one or more of the methods discussed herein, may be executed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Machine reasoning systems are built with assumptions about a target environment. The assumptions are often a poor reflection of reality. Examples of such assumptions include prior probabilities for probabilistic reasoning systems and training data for artificial intelligence (AI) systems. That the assumptions are a poor reflection of reality in many cases weakens the reliability and trust of the systems. The weakness of the assumptions further pose risk to those tasked with taking action based on system inference.

Previously, rule-based expert systems tried to provide inference without prior probabilities; but, these rule-based expert systems were brittle. They were brittle because these systems were based on basic predicate or first order logic (FOL) which can't handle certain kinds of rule sets or situations in the field with incomplete or contradictory evidence. These prior systems also rarely incorporated multi-valued quantifications over rules, e.g. probabilistic quantifiers. Computational complexity tended to be exponential as the modeling within these systems was essentially that of a satisfiability (SAT)-solver.

Embodiments are not looking to see whether conditions can satisfy arbitrary predicates under a complex system of statements. Instead, embodiments are more closely related to current Al systems and probabilistic systems in that embodiments ascertain a quantified judgement on a single object or event of interest. This judgment is independent of statistical properties about the domain of discourse measured from data in the system, or the various conditions under which different logical statements are satisfied. Embodiments also do not require the use of priors, which in existing art can be unreliable as previously stated, and whose unreliability can only be mitigated within particular types of probabilistic models, and then only by adding more training data, which may be unreliable as well (in unseen environments, training data is unavailable and proxy synthetic data is used for model training-this data may be entirely synthetic, or it may be based on a very small number of examples that do not sufficiently represent the environment).

Embodiments regard systems in which operators (considered an example of a “subject matter expert” (SME)) can directly specify beliefs about indicators of events of interest. The operator need not also specify how likely those indicators or activities are. Even without the likelihood that the indicators occur being specified in advance, embodiment can provide reasoning capabilities.

Embodiments regard monitoring, reacting to, or otherwise acting in light of events of interest. An event of interest may be a complex phenomenon with a plurality of evidence for whether the phenomenon has taken place, or it may be the occurrence of a similarly complex entity whose existence can be determined from a plurality of evidence. In a miliary context, these entities can include battalions, missile systems, computer networks, or the like. Embodiments can fuse data about multiple indicators of events of interest, such as from multiple intelligence sources, across time to produce a quantified assessment of whether the event has taken place. The event can be any device, person, occurrence, or object of interest to the operator. The pieces of evidence that are used in the decision may be probabilistic, and prior probabilities that the event has taken place may not be available and is not required for embodiments to operate.

Embodiments provide an automated system for leveraging knowledge about how strongly different evidence that may indicate the event of interest affect the confidence that the event has in fact taken place without needing to specify priors on the event or its indicators in unseen environments, particularly in operator areas of interest wherein determinations regarding events of interest are consequential.

Embodiments determine a probability that an event has taken place given the evidence seen by the system. Embodiments leverage a quantified set of operator rules that are interpreted as strict conditionals on a common consequent. This common consequent is a logical variable representing the event of interest. The quantification on operator rules are probabilistic, and those rules involve antecedents which are the evidence provided to the system. The antecedents can also be probabilistic. Embodiments process those inputs and produce metrics including the probability of various inference outcomes for the event of interest At a high level, embodiments accomplish the inference by first capturing operator knowledge as a set of modal logic statements, specifically strict conditionals with axiom T as a rule of inference (e.g., p(□(evidence->event) (read as “probability that the evidence necessarily (in an epistemic or actual knowledge sense) suggests that the event is true”), jointly modeling the probabilities of evidence and rules as encoding a set of worlds subject to a type-2 probability distribution, and computing a set of metrics which produce a single unified value representing the most likely truth value for the event of interest, and the certainty associated with it. Unlike a probability value, this value at its midpoint does not represent a 50% probability, but instead represents complete uncertainty-in other words, the midpoint of our metric encodes a reasoning outcome that the true chance of an event occurring may be anything at all (25%, 99%, and so on).

There are at least three aspects of embodiment, which, to the best of the knowledge of the inventors are new and are non-obvious: (1) Framing a probabilistic problem in terms of strict conditionals, (2) Construction of a set of worlds (in the sense of modal logic) as a representation of a set of probabilities on those conditionals; (3) Mechanisms for inference under axiom T in light of (1), (2), or a combination thereof. There is no prior art that explicitly shows or leverages the link between valid inference under axiom T (reflexive models) and conditional probability. Embodiments make explicit use of that link for reasoning about events of interest from evidence to produce metrics for decision making. Embodiments solve problems of prior solutions including an inability to fuse multiple pieces of positive and negative evidence through the use of a conservative modal logic. The axioms employed are not controversial (e.g., S5 or even S4 are not employed). Embodiments are able to entirely restrict the rules of inference leveraged by the system to those contained in T.

Embodiments are not limited to just defense and tactical applications. Embodiments are applicable to any system with uncertain and incomplete knowledge regarding priors wherein indicators of events of interest can be represented and quantified in the form of strict conditional beliefs with associated confidence. Embodiments are applicable to any system in which the predictive strength of an indicator for an event can be quantified. Decision making tools of several varieties fit this description. Some notional examples include (1) bot/troll identification in social networks (e.g., p(□(mechanistic posting intervals->bot))=0.5 . . . ), (2) deep fake identification (e.g., p(□(frame artifacts->fake))=0.1 . . . ), (3) medical testing (e.g., p(□(test defect A->invalid result))=0.2), (4) stock market analysis (e.g., p(□(midterms end in 15 days->positive returns in 30 days))=0.8), among many others.

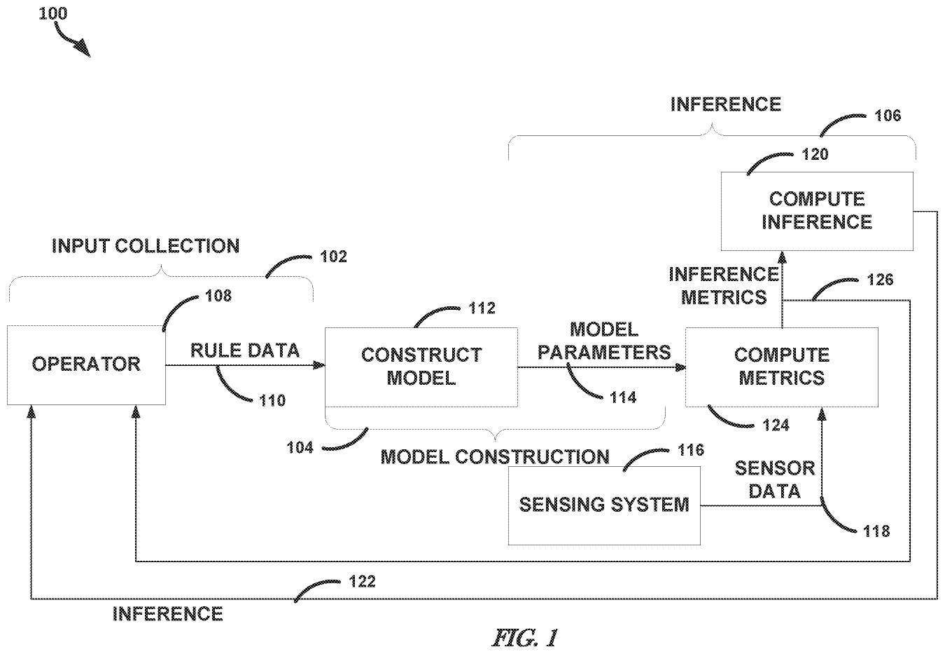

FIG. 1 illustrates, by way of example, a diagram of an embodiment of a system 100 for improved event inference (e.g., indicating presence of an event or object of interest). The system 100 can operate without prior probabilities. The system 100 as illustrated operates in three phases, input collection phase 102, model construction phase 104, and inference phase 106.

Input collection phase 102 includes receiving, retrieving, or generating rule data 110 based on operator 108 input. The operator 108 is the person or group of persons responsible for managing assets and personnel in a specified geographic region. The operator 108 defines the rule data 110 that is used to for the model construction phase 104 (model construction operation 112). The rule data 110 focuses on the empirical knowledge retained by the operator 108. This is in contrast to a prior probability or using theory or another model to predict what happens in the geographic region.

The input collection phase 102 can include quantifying positive and negative evidence (X) of an event of interest (y). The event of interest is sometimes called a “target” or “target variable” (this is common language in AI), and hence the presence or truth of the target variable as calculated by the inference discussed herein is representative of the presence or truth of the event of interest-the terms “event of interest”, “target”, “target variable” may be used interchangeably for the purposes of discourse. The operator 108 can provide information like, “when evidence, x, is present, the event of interest, y seems to occur with probability p(y|x)”. This sort of information is called a positive indicator since the presence of the evidence increases the likelihood that the event of interest has occurred or is going to occur. The operator 108 can provide information like “when evidence, x, is present, the event of interest, y seems to not occur with probability p(−y|x)”. This sort of information is called a negative indicator since the presence of the evidence decreases the likelihood that the event of interest has occurred or is going to occur. The rule data 110 can thus be a set of positive indicator evidence and a set of negative indicator evidence. Questions posed to the operator 108 in gathering the rule data 110 can include:
Is there evidence that, when realized, makes you think that the event of interest will occur? (e.g., Table 1 variables x,m,n)
If so, what is the evidence and what is the likelihood that the event of interest does occur if the evidence is gathered? (e.g., Table 1 variables a,b,c)
Is there evidence that, when realized, makes you think that the event of interest will not occur? (e.g., Table 1 variables d,e,f)
If so, what is the evidence and what is the likelihood that the event of interest does occur if the evidence is gathered? (e.g., Table 1 variables o,q,r)

In mathematical form, the gathered evidence can take the form in Table 1.

TABLE 1
mathematical representation of the rule data 110.

| Negative Indicators | Positive Indicators |
|---|---|
| p(□(o → ¬y)) = d | p(□(x → y)) = a |
| p(□(q → ¬y)) = e | p(□(m → y)) = b |
| . . . | . . . |
| p(□(r → ¬y)) = f | p(□(n → y)) = c |

The model construction phase 104 converts the natural language rules provided by the operator 108 into model parameters 114. The model parameters 114 can be first specified using more widespread probability notation and then converted to modal notation as shown in Table 1, however, no explicit notation is required for processing; we will discuss later and show in pseudocode how the probabilities of rules and evidence are sufficient to fully specify the computational model; the modal representation in Tables 1 and 2 serve as an aid to understanding the model parameterization.

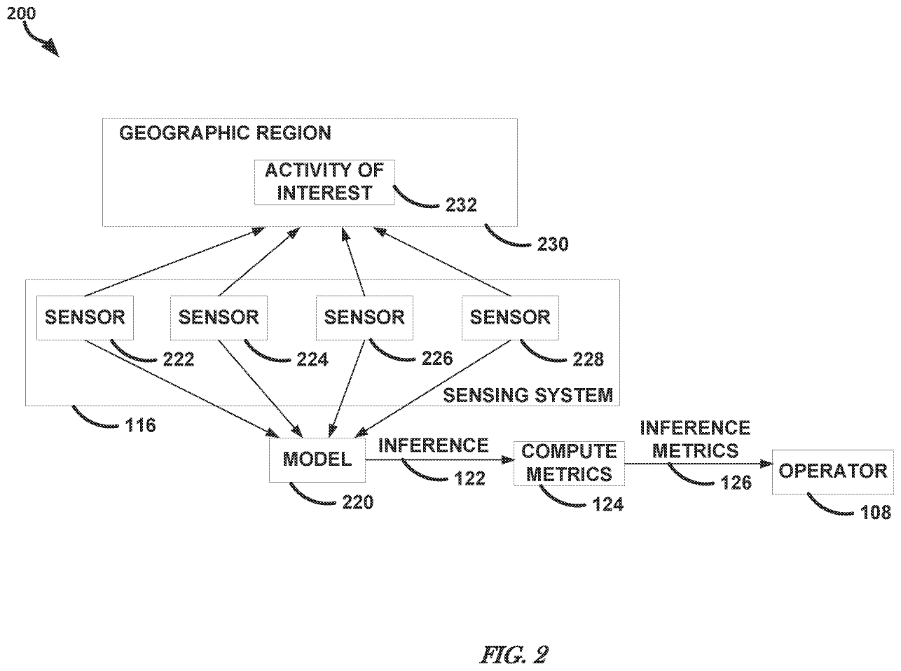

The model construction phase 104 can include three operations. The operator 108 selects a subset of the system variables which they believe to be correlated to the activity of interest (see FIG. 2). This set is referred to as the set of evidence variables.

For each entry in the set of evidence variables, the user defines a confidence value and a sign (+/−1). The sign, if positive, reflects the belief that the variable is a positive predictor of the target variable. If negative, it reflects the belief that the variable is a negative predictor of the target variable. The confidence value ranges from 0 to 1, where 0 encodes no confidence in the belief, and 1 encodes complete confidence in the belief. The confidence values and signs may also be provided by statistical means such as correlation measurements, artificial intelligence methods, and so on. In some embodiments, confidence value and sign may be jointly encoded; e.g. a negatively signed variable with confidence 1 may simply be encoded as −1. We treat them as separate in this disclosure for simplicity.

Table 2 shows how statements from the operator 108 are encoded into probability notation during model construction phase 104.

TABLE 2
conversion of Operator statements to model constructs.

| Operator Rule | Encoding |
|---|---|
| “If I see x, I think y has probability q” | p(□(x → y)) = q |
| “If I see x, I think y is not there with | p(□(x → ¬y)) = q |
| probability q” | |
| “If I see x, I think y has probability q, | p(□((x&¬a) → y)) = q |
| unless I see a” | |
| “If I see x and b, I think y is not there | p(□((x&b) → ¬y)) = q |
| with probability q” | |

The statements provided by the operator 108 can be aggregated as quantified strict conditionals. The inference phase 106 can use the strict conditionals to perform probabilistic reasoning. The probabilistic reasoning is a type 2 probabilistic reasoning in which inference is made on the event of interest over a set of possible worlds under which both rules and evidence are true or false according to the provided probability (rule probabilities from the operator; evidence probabilities from the connected system).

Rather than assuming the existence of reliable prior probabilities, assuming various statistical forms that a distribution satisfies, assuming that there is a sufficient amount of representative training data, and so on, embodiments model the rules from the Operator 108 as strict conditionals. The models operate under the assumption that strict implication adequately represents intent of the Operator 108. The approach of embodiments requires no training data, no input/output examples, or the like. Instead, the rule data 110 provided by the operation 108 defines the model parameters 114 and thus defines a model that is used to compute an inference 122.

The probabilities determined from the operator 108 statements are encoded as probabilistic modal logic statements. An example conversion is provided:

$$“ I believe that x predicts y with w confidence ” a {\to }_{convert} p ( □ ( x \to y ) = a \qquad Equation 1$$

In Equation 1, x is evidence, y is an event of interest, and a is a quantification of the belief that x predicts y. The system will later assign a probability to whether or not x is true which will be used for inference about y.

Rules, represented by the rule data 110 and sometimes called the model parameters 114, are constructed differently based on whether the operator 108 provides assertions like ‘the indicator is/is not present’ vs ‘we did/did not see the indicator’. The rules and antecedents, when used to construct a set of worlds for probabilistic reasoning are an application of a type-2 probability system. The conditional interpretation of if-then rules in type-1 probability systems is very different from the type-2 paradigm. The type-2 probabilities that can be computed under the modal logic construction described herein using strict conditionals are not possible in a type-1 probability system, as type-1 systems cannot combine logical and probabilistic reasoning. Further, the probabilities computed herein are not possible using a type-2 probability system without the use of modal logic and the strict conditional (using only the material conditional) In fact, it has been said, that the if-then statement approach possible in type-1 paradigms is “so fundamentally wrong that its maladies cannot be rectified simply by allowing exceptions in the form of shaded truth values [i.e. attaching uncertainty values to the statements]”—Probabilistic Reasoning in Intelligent Systems: Networks of Plausible Inference p. 24.

The inference phase 106 includes receiving sensor data 118 from a sensing system 116. The inference phase 106 further includes computing an inference 122 based on the sensor data 118 and the model parameters 114. Computing the inference 122 takes the model parameters 114 from the operator 108 provided rule data 110 (in type-2 probability form, in other words, a probability stated over a universe of possible worlds). Computing the inference 122 can use the sensor data 118 from sensing system 116, to instantiate probabilities of antecedents (representing evidence) to generate an inference 122. The inference 122 is used in a compute metrics operation 124 resulting in inference metrics 126. The inference metrics 126 are human understandable semantics that encode uncertainty for a truth value of an event of interest.

A computing the inference operation 120, to generate the inference 122, can be performed using the following equations.

$$\begin{matrix}1 - {\prod }_{{< {r}^{t} , {x}_{{r}^{t}} > ∈ v}^{}} 1 - p ( {r}^{t} ) p ( {x}_{{r}^{t}} ) = p ( {R}_{\hat{w}} ⊢ y ) \\ 1 - {\prod }_{{< {r}^{f} , {x}_{{r}^{f}} > ∈ v}^{}} 1 - p ( {r}^{f} ) p ( {x}_{{r}^{f}} ) = p ( {R}_{\hat{w}} ⊢ ¬ y ) \\ {\prod }_{{< {r}^{t} , {x}_{{r}^{t}} > ∈ v}^{}} 1 - p ( {r}^{t} ) p ( {x}_{{r}^{t}} ) = p ( {R}_{\hat{w}} y ) \\ \begin{matrix}{\prod }_{{< {r}^{f} , {x}_{{r}^{f}} > ∈ v}^{}} 1 - p ( {r}^{f} ) p ( {x}_{{r}^{f}} ) = p ( {R}_{\hat{w}} ¬ y ) \\ ε = {\prod }_{{< {r}^{t} , {x}_{{r}^{t}} > ∈ v}^{}} 1 - p ( {r}^{t} ) p ( {x}_{{r}^{t}} ) \\ τ = {\prod }_{{< {r}^{f} , {x}_{{r}^{f}} > ∈ v}^{}} 1 - p ( {r}^{f} ) p ( {x}_{{r}^{f}} )\end{matrix}\end{matrix}$$

Table 3 details different calculations that can be performed to provide information about the system being modeled.

TABLE 3
different inference metrics that provide information about the
system being modeled.

| Probability of | y | ¬y | Formula |
|---|---|---|---|
| Inconsistency | ├ | ├ | (1 − ε)(1 − τ) |
| Certain truth | ├ | [symbol] | (1 − ε)τ |
| Certain falsity | [symbol] | ├ | (1 − τ)ε |
| Ambiguity | [symbol] | [symbol] | τε |
| | | | Σ = 1 |

The operation 120 can be performed under the assumption that the rules, represented by the rule data 110 and provided by the operator 108, are always consistent. That is, the assumption is strict that there is no world in which both evidence for truth and falsity of y exists as in the following Equation:

$${φ}_{strict} = \frac{CT}{C T + A} - \frac{C F}{C F + A} = τ - ε$$

Where CT is certain truth, CF is certain falsity, and A is ambiguity.

The operation 120 can be performed under the assumption that the world is consistent, although sensors may be wrong or rules may be off by some small factor. That is, the assumption is permissive such that certain rules with certain antecedents will in all possible worlds yield an inference of ‘true’ for the event of interest as in the following Equations:

$$\begin{matrix}{φ}_{permissive} = ( a + b ) ( 1 - c ) [ - a ( ε + τ - 2 ) + ε - 1 ] + τ - ε \\ H ( x ) = \{ \begin{matrix}1 , & x > 0 \\ 0 , & x \leq 0\end{matrix} \\ a = H ( τ - ε ) \\ b = H ( ε - τ ) \\ c = H ( ( 1 - ε ) τ ( 1 - τ ) ε )\end{matrix}$$

A heaviside step function can be used because the atoms themselves are discrete—there is ample precedent in traditional probability of this function, and especially its derivative (Dirac delta function). The system essentially takes input statements, computes a probability distribution over 4 outcomes on y from sensor data, and computes signed measures with the appropriate semantics. Note that all of these formulas can be represented as linear equations, (e.g., p(R_{ŵ}|−y)=1.0−Determinant(IdentityMatrix[{|R_{ŵ}|,|R_{ŵ}|}]*[1.0−[{p(r^{t})p(aᵣ_{^{t}})| [symbol] r^{t},aᵣ_{^{t}} [symbol] ∈U}]]).

An example justification for the probability of being able to validly infer that an event of interest, y, is true as follows: Across the set of worlds, let p(r^{t}) be the probability that a rule is true and p(aᵣ_{^{t}}) be the probability that the antecedent for rule r is true. Only rules with true consequents (positive evidence) can be used to infer y, and then only when their antecedents [the sensor data 118] are true. It only takes one such (rule, antecedent pair) to validly infer y. Therefore, the probability of validly inferring y is 1—the probability of being in a world where there is no such rule, antecedent pair:

$$p ( {R}_{\hat{w}} ⊢ y ) = 1 - {\prod }_{〈 {r}^{t} , {a}_{{r}^{t}} 〉 ∈ U} 1 - p ( {r}^{t} ) p ( {a}_{{r}^{t}} )$$

The inference 122 can be a value in a range of real numbers or similar. The range can be [−1, 1] where −1 means that “y is false” is certain to be a valid inference, 0 means complete ambiguity, and 1 means that “y is true” is certain to be a valid inference. The inference 122 is the output of the φ function. Inference metrics include the probabilities in Table 3. The inference metrics 126 are explanatory metrics that shed light on how the inference 122 was made and why. The range of φ is between −1 and 1 in the general case. Under certain rule configurations, it may be constrained to [−1, 0] such as when only negative indicators are provided, or to [0,1], such as when only positive indicators are provided.

The operation 124 can include determining the values in Table 3. The result of the operation 124 is inference metrics 126. The inference metrics 126 can be provided to the operator 108, so that the operator 108 can make a decision.

The inference metric 126 is very understandable: −1.0 equates to a Boolean false with 100% certainty, also to a probability of zero of the event given the rules. Moving toward zero is still a Boolean false, but with increasing uncertainty about the inference. Zero is complete uncertainty. From zero to one is moving from complete uncertainty through ‘leaning towards true’ to complete confidence that y can be inferred from the rules and system data.

The inference metric 126 is explainable: The operator 108 is in complete control of the rule set. All inferences can be understood in terms of those rules, and the probability that in aggregate, the event of interest can be inferred to be true or false given the system data. The inference 122 includes not only complete traceability back to operator rules (the rule data 110) and system inputs (sensor data 118), but can also be understood in terms of semantically

straight-forward metrics provided by [0032] for ambiguity, inconsistency, and consistency for truth values of the consequent.

Embodiments provide a model from which the inference 122 can be computed. The model is comprised of strict conditionals with a common consequent as a target variable for machine inference. That is, embodiments provide a modal logic based machine inference model constructed from rule data. That model partially specifies a set of worlds which are fully specified at inference time given system data from the connected system. The fully specified set of worlds is sufficient for the inference described herein. Embodiments operate using type 2 probability structures that operate over a modal universe with defined processes for inference on an event of interest (using axiom T in conjunction with probabilistically instantiated rule and evidence logic sentences). Embodiments can include a determination of several metrics that can be computed from the model given data from a sensing system.

A Type 2 probability system” denotes a system of probabilistic reasoning over a set of states. This is opposed to a Type 1 probability system that denote a probability over a domain of objects. In embodiments, each “world” is a possible state comprised of multiple domain objects (event of interest and all evidence) and different sets of rules according to the probabilities provided by the operator 108 for rule confidence. By constraining the set of states to 1) containing only conditionals whose consequent is the event of interest, and their antecedents and 2) using the rule and evidence probabilities to determine the truth values of the statements in 1 for each world, embodiments have constructed a set such that it supports type-2 probabilistic reasoning from which we can derive inference metrics on the event of interest.

“Axiom T” is an inference rule in modal logic which states that if something is necessary in a world (box), then it is True: (e.g., if it is necessary from a set of conditions that a tank exists, then it does exist).

FIG. 2 illustrates, by way of example, a diagram of an embodiment of a system 200 that includes a model, generated by the system 100, in operation. The system 200 as illustrated includes a model 220 (defined by the model parameters 114) that receives input from the sensing system 116 (in FIG. 2 the sensing system 116 includes sensors 222, 224, 226, 228). The model 220 determines the inference 122. The inference 122 is used as input to the operation 124. The operation 124 determines the inference metrics 126 that are provided to the operator 108. The operator 108 makes a decision regarding an activity of interest 232 in a geographic region 230.

The sensing system 116 produces sensor data 118 that is used as evidence for input to the model defined by the model parameters 114. Example sensors that can be included in the sensing system 116 include ambient condition sensors (e.g., pressure, temperature, wind speed, wind direction, relative humidity, evaporation, ultraviolet or solar radiation, precipitation, chemical, leaf wetness, negative ion, soil ph, soil npk, noise, or the like), image sensors (e.g., an imaging device, such as range detection and ranging (RADAR), light detection and ranging (LIDAR), sound detection and ranging (SONAR), optical, electrooptical, super spectral, infrared, or the like), object recognition system, tracking system, or the like. While there are four sensors 222, 224, 226, 228 illustrated in FIG. 2, more or fewer sensors can be used.

The system 200 is sometimes called a connected system. A connected system is one which provides measurements on a subset of the variables in a domain of discourse (the geographic region 230 in the example of FIG. 2). In general, the connected system is a computing system which processes measurements from sensors or aggregates and processes measurements from other computing systems. The model 220 can operate directly on the connected system that directly ingests measurements from the sensing system 116 or on another computing system which ingests measurements from the connected system.

As used herein a “Domain of discourse” is: A set of probabilistic atomic variables including system variables the connected system provides measurements for via the sensing system 116, and a single specified target variable for which the connected system does not provide measurements.

A “Strict Conditional” is a logical statement of the form □(a→b) where □ is the modal logic quantifier for necessity, a is the antecedent (sometimes called evidence) of the conditional, and b is the event of interest (→denotes implication). The inference over worlds in the model 220 computes probabilities of different inference 122 outcomes across a set of worlds, where the model 220 inference system includes the standard modal logic axiom T which states □a→a, or roughly ‘if a is necessary, then a is the case’, and wherein for some worlds, a strict conditional will be true, and in others, it will be false. In worlds where the strict conditional is false (i.e. ¬□(a→b)), and the consequent is true (satisfied given other antecedent/conditional pairs), the box operator precludes contradiction. This contrasts with the negation of a material conditional wherein the statements ¬(a→b) and b give a contradiction since ¬(a→b) implies ¬b. In other words, the box operator, in cases where the conditional is false, prevents the model 220 from assuming anything about b so that antecedents tied to true conditionals can produce truth values for the event of interest in a consistent manner without contradiction.

The set of evidence variables and associated signs and confidence values are stored and jointly constitute the model 220. Each element in model 220 is referred to as a rule. The interpretation of the model 220 is a set of confidence-weighted strict conditionals, each of which relates an evidence variable to a particular truth value of the activity of interest 232.

Example rule setup and model interpretation:

### Setup

Operator belief number 12: “80% of the time, if there is smoke, there is fire”
Target variable: “there is fire”
System data: There is smoke with 100% probability
Desired output: a confidence of probability measurement on the statement “there is fire”

### Reflexive Model:

Model interpretation: p(□(s→f))=0.8
Rule: [symbol] 12, positive, 0.8 [symbol]
Output: A 0.8 confidence for the statement ‘there is fire’
Note: In some embodiments, rule arrays may be accessed by index, removing a need for the first element in the tuple above. Positive and negative rules may also be stored in their own arrays, removing the need for a sign. Positive and negative rules are treated as separate in this disclosure for simplicity.

Operating on the rule using a Bayesian approach, which is contrasted with embodiments:
In this situation one is looking to estimate p(f) given p(f|s). Say p(f)|s)=0.8 is a known posterior probability, and the marginal p(s)=1.0 is received from the system, one must assume that p(s|f)*p(f) also equals 0.8 by Bayes Rule. To determine the prior, p(f), one would be forced to give the likelihood p(s|f) which may not be provided by the connected system (for this example, note that hydrogen fires do not produce smoke). One may also consider providing a prior on p(f) and updating probabilities based on further information and rules, however this assumes that one has a known history of fires in the environment for sampling from or to form the basis for a user belief-in many cases such history is inaccessible or even non-existent. The output of such an approach is nothing without additional information.

Embodiments do not require the likelihoods or priors that are required for the Bayesian techniques (or other similar techniques). Instead embodiments leverage a type-2 probability system over a set of modal worlds suggested by the model 220 to perform inference. In this case, in 80% of the worlds, the statement □(s→f) is true, and in the other 20%, it is false. As with type-1 probability calculations, one does not need to explicitly store the set of all possible worlds-the probability of the statement represents the set sufficiently for the inference 122.

As with most statistical processes, an assumption encoded in the model 220 is that the rules are applicable to the inference environment.

```
Pseudocode
BuildModel(S) is:
      M = { }
      While input.inProgress:
            r = <>
            r.index = input({s.index for s in S})
            r.p = input(0 to 1 value)
            r.sign = input(positive, negative)
            M = M ∪ {r}
      Return M
Quantify(M, E) is
      Qₚ:= { }
      Qₙ:= { }
      For r ∈ M:
            e := E[r.index]
            If e.isMeasured:
                  If r.sign is positive:
                        Qₚ:= Qₚ ∪ { [symbol]   r, e [symbol]   }
                  Else:
                        Qₙ:= Qₙ ∪ { [symbol]   r, e [symbol]   }
      Return Qₚ, Qₙ
Condition(Q) is:
      x := 1
      For q ∈ Q:
            x := x * [1 − q.s.p * q.r.p]
      Return x
Certainty Strict(ε, τ) is:
      Return τ − ε
Heaviside(x) is:
      If x > 0:
            Return 1
      Else:
            Return 0
CertaintyPermissive(ε, τ) is:
      A = Heaviside(τ − ε)
      B = Heaviside(ε − τ)
      C = Heaviside((1 − ε)τ(1 − τ)ε)
      Return (a + b)(1 − c)[−α(ε + τ − 2) + ε − 1] + τ − ε
Infer(M, E, Strict) is:
      < Qₚ, Qₙ> := Quantify(M, E)
      ε = Condition(Qₚ)
      τ = Condition(Qₙ)
      Inf = <>
      Inf.inconsistancy := (1 − ε)(1 − τ)
      Inf.ctruth := (1 − ε)τ
      Inf.cfalsity := (1 − τ)ε
      Inf.ambiguity := ετ
      If Strict:
            Inf.inference := CertaintyStrict(ε, τ)
      Else:
            Inf.inference := CertaintyPermissive(ε, τ)
      Return Inf
```

### Operational Workflow

BuildModel(S) is called on the system S (a computer system that can operate the model 220). S is assumed to have an indexing structure containing the available evidence capabilities such that, for example, S[index] will return a reference to the capability. The measurement capabilities S[index] are expected to correspond to the system measurements of evidence E[index] and to the rules of M[index] (indices are assumed to be aligned for the purposes of this pseudocode but need not be aligned).

As system data is ingested, the function Infer( ) is called on available evidence, E, to provide the inference 122. The function Infer( ) takes three parameters and returns a real-valued inference and explanatory metrics (in some embodiments the explanatory metrics may not be required). The parameters are
a. The model from BuildModel, M
b. Evidence from the connected system, E
c. A Boolean parameter the operator chooses, Strict or Permissive

The output of the Infer( ) function is an infer object containing:

Inference: a [−1, 1] valued real number whose readings are interpreted as follows:
−1 indicates certainty that the available evidence evaluated against the rules suggests that the target variable has a truth value of false
0 indicates that the available evidence evaluated against the rules suggests that the target variable has a completely uncertain truth value
1 indicates certainty that the available evidence evaluated against the rules suggests that the target variable bas a truth value of true

When strict mode is indicated by the Boolean parameter (e.g., is set to true), this encodes the assumption that the rules will always produce consistent results against any set of system data. When it is set to false (permissive mode), this encodes the assumption that the world is consistent, i.e. although sensors may be wrong or rule weights may be off by small factor, certain rules with certain antecedents yield certain consequents-this has the effect of clamping the inference values as follows:
−1 when at least one <antecedent, rule> pair takes the value <1,−1>
1 when at least one <antecedent, rule> pair takes the value <1,1>
0 when the first two conditions are both satisfied.

Explanatory Variables: As the model encodes a type-2 probability distribution over worlds, there are certain salient properties of the distribution that explain the value of the certainty measure. It should be noted here that in each world, the evidence variables are probabilistically assigned to either true, or false, yielding several possible situations. For example, a rule with sign 1 for antecedent x with confidence 0.8 and the target variable y encodes that there is an 80 percent chance that a given world will contain the statement □(x→y). i.e. the rule has a truth value of true, and a 20 percent chance that the world will instead contain the statement ¬□(x→y), i.e. the rule has a truth value of false. Similarly, when the system measures an 80 percent probability of antecedent x, this encodes that there is an 80 percent chance that a given world will contain the statement x, and a 20 percent chance that the world will instead contain the statement ¬x. The four explanatory variables (in Table 3) are mutually exclusive with respect to a single world, and always sum to one across the set of worlds; they may be thought of as jointly constituting a probability distribution over the four possible inference outcomes on the target variable over the set of worlds that the rule and antecedent probabilities suggest. The explanatory variables are
Inconsistency: Represents the probability that in any given world, the truth values for rules and antecedents may be used to produce both true and false truth values for the target variable
Certain Truth: Represents the probability that in any given world, the truth values for rules and antecedents yield a truth value of true for the target variable and cannot yield a value of false
Certain Falsity: Represents the probability that in any given world, the truth values for rules and antecedents yield a truth value of false for the target variable and cannot yield a value of true
Ambiguity: Represents the probability that in any given world, the truth values for rules and antecedents do not yield any truth value for the target variable

Examples highlighting some operation of the model:
1. In this example, the activity of interest 232 for inference 122 is the statement ‘is fire’. The operator 108 has encoded the rule data 110 for gas being a positive indicator with 0.5 confidence, water being a negative indicator with 1.0 confidence, smoke being a positive indicator with 0.9 confidence, and flame being a positive indicator with 1.0 confidence. The connected system measures a 1.0 probability of smoke and water, and a 0.0 probability of gas and flame.
   Rules: [Rule<gas, 0.5, 1>, Rule<water, 1.0,−1>, Rule<smoke, 0.9.1>, Rule<flame, 1.0,1>]
   System Evidence: {‘gas’: 0.0, ‘smoke’: 1.0, ‘water’: 1.0, ‘flame’: 0.0}
   Qp: {Rule<gas,0.5,1>: 0.0, Rule<smoke,0.9,1>: 1.0, Rule<flame, 1.0, 1>: 0.0}
   Qn: {Rule<water, 1.0,−1>: 1.0}
   eps: 0.1
   tau: 0.0
   Output (permissive): {'inference':−1.0, ‘inconsistency’: 0.9, ‘certain_truth’: 0.0, ‘certain_falsity’: 0.1, ‘ambiguity’: 0.0}
   Output (strict): {‘inference’:−0.1, ‘inconsistency’: 0.9, ‘certain_truth’: 0.0, ‘certain_falsity’: 0.1, ‘ambiguity’: 0.0}
2. In this example, the activity of interest 232 for the inference 122 is the statement ‘stocks go up’. The operator 108 has encoded the rule data 110 for the recent completion of an election cycle being a positive indicator with 0.8 confidence, and the current day being Monday being a negative indicator with probability 0.25. The connected system measures a 0.0 probability of a recent election cycle completing, and a 1.0 probability of it being a Monday.
   Rules: [Rule<presidential_election_completed, 0.8,1>, Rule<monday, 0.25,-1>]
   System Evidence: {'presidential_election_completed': 0.0, ‘monday’: 1.0}
   Qp: {Rule<presidential_election_completed,0.8,1>: 0.0}
   Qn: {Rule<monday,0.25,-1>: 1.0}
   eps: 1.0
   tau: 0.75
   Output (permissive): {'inference':-0.25, ‘inconsistency’: 0.0, ‘certain_truth’: 0.0, ‘certain_falsity’: 0.25, ‘ambiguity’: 0.75}
   Output (strict): {'inference':-0.25, ‘inconsistency’: 0.0, ‘certain_truth’: 0.0, ‘certain_falsity’: 0.25, ‘ambiguity’: 0.75}
3. In this example, the activity of interest 232 for the inference 122 is the statement ‘is a bot’. The operator 108 has encoded the rule data 110 for detected machine posting patterns being a positive indicator with 0.95 confidence, and the account belonging to a verified user being a negative indicator with 0.95 confidence. The connected system reads posts and measures a 0.5 probability of a machine posting pattern, and a 0.0 probability that the account has been verified to belong to a real person.
   Rules: [Rule<machine_posting_pattern, 0.95,1>, Rule<verified_account, 0.95,-1>]
   System Evidence: {'machine_posting_pattern': 0.5, ‘verified_account’: 0.0}
   Qp: {Rule<machine_posting_pattern,0.95,1>: 0.5}
   Qn: {Rule<verified_account, 0.95,−1>: 0.0}
   eps: 0.525
   tau: 1.0
   Output (permissive): {‘inference’: 0.475, ‘inconsistency’: 0.0, ‘certain_truth’: 0.475, ‘certain_falsity’: 0.0, ‘ambiguity’: 0.525}
   Output (strict): {‘inference’: 0.475, ‘inconsistency’: 0.0, ‘certain_truth’: 0.475, ‘certain_falsity’: 0.0, ‘ambiguity’: 0.525}
4. In this example, the activity of interest 232 for the inference 122 is the statement ‘is valid test result’ which may apply to any number of domains (medical testing, software testing, machine testing, and so on). The operator 108 has encoded the rule data 110 for two measurable defects in the test procedure, and two confirmations of the test result. The connected system provides probabilistic measurements from the two confirmation procedures each at 0.5, and the defects at 0.25 and 0.75.
   Rules: [Rule<defect_a,0.5,-1>, Rule<confirmation_procedure_a,0.75,1>, Rule<defect_b,0.25,-1>, Rule<confirmation_procedure_b,0.75,1>]
   System Evidence: {'defect_a′: 0.25, ‘confirmation_procedure_a’: 0.5, ‘defect_b’: 0.75, ‘confirmation_procedure_b’: 0.5}
   Qp: {Rule<confirmation_procedure_a,0.75,1>: 0.5, Rule<confirmation_procedure_b,0.75,1>: 0.5}
   Qn: {Rule<defect_a,0.5,-1>: 0.25, Rule<defect_b,0.25,-1>: 0.75}
   eps: 0.390625
   tau: 0.7109375
   Output (Permissive): {'inference': 0.3203125, ‘inconsistency’: 0.1761474609375, ‘certain_truth’: 0.4332275390625, ‘certain_falsity’: 0.1129150390625, ‘ambiguity’: 0.2777099609375}
   Output (Strict): {'inference': 0.3203125, ‘inconsistency’: 0.1761474609375, ‘certain_truth’: 0.4332275390625, ‘certain_falsity’: 0.1129150390625, ‘ambiguity’: 0.2777099609375}

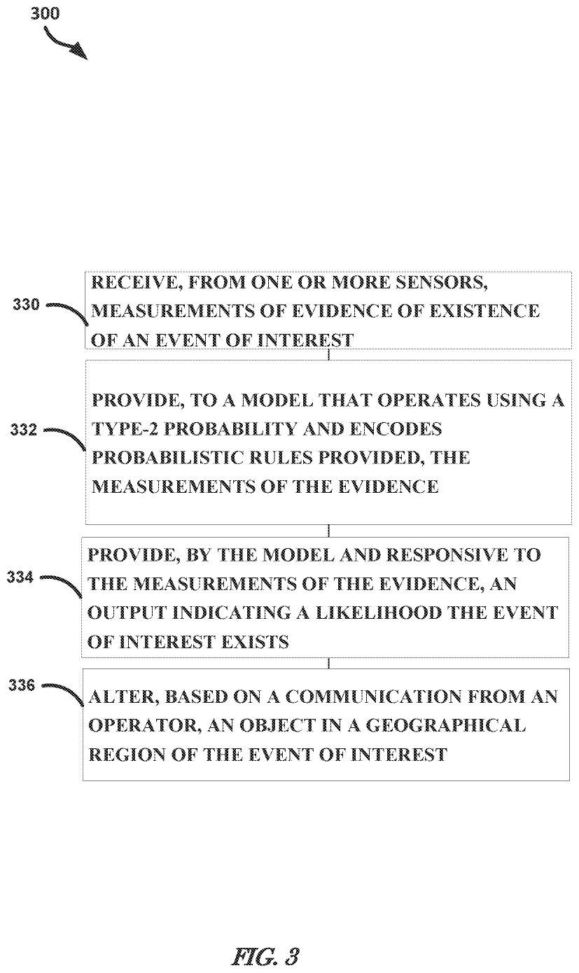

FIG. 3 illustrates, by way of example, a diagram of an embodiment of a method 300 for inference and action. The method 300 as illustrated includes receiving, from one or more sensors, measurements of evidence of existence of an event of interest, at operation 330; providing, to a model that operates using a type-2 probability and encodes probabilistic rules provided by a subject matter expert (SME) of the event of interest, the measurements of the evidence, at operation 332; providing, by the model and responsive to the measurements of the evidence, an output indicating a likelihood the event of interest exists, at operation 334; and altering, based on a communication from the SME, an object in a geographical region of the event of interest, at operation 336.

The one or more sensors can include an imaging device or a weather sensor. The method 300 can further include receiving, from the SME and by a UI, an input indicating whether a model is to operate in permissive mode or strict mode. The permissive mode operates under an assumption that the geographic region of the event of interest is consistent and the strict mode operates under an assumption that the rules are consistent.

The output can further include respective probabilities of certain truth, certain falsity, ambiguity, and consistency. The output can further include a single value that indicates a likelihood of existence and non-existence of the event of interest. The method 300 can further include receiving, from the SME of an event of interest and by a user interface (UI), probabilistic rules associating the evidence with existence of the event of interest. The rules can include rules that positively associate the existence of the event of interest with first evidence and negatively associate the existence of the event of interest with second, different evidence.

In traditional probability regimes, one can use some probabilities to derive other probabilities. However, the information needed to derive the other probabilities is not always available. Consider the following problem statement: “On any given day, I make a decision about whether to cook breakfast, b. That decision depends on some measurable independent events: (i) If I am hungry, h, then I cook breakfast; (ii) I will not cook breakfast, b, unless I have time, t; (iii) When I am hungry, h, the probability that I cook breakfast is proportional to what is in the fridge, f; (iv) I do not track my meals or ingredients, so I have no prior knowledge of P(b), P(b∩x), or P(x|b) for any x in h, t, f.”

If one were to interpret this problem statement using a Bayesian paradigm, one will find that information is missing to determine a probability of cooking breakfast. That is P(b|x)=P(x|b)P(b)/(P(b) and P(b)=P(b|x)P(x)/P(x|b) are not fully determinable based on the information provided.

If one were to interpret this problem statement as P(b)=P(h)P(t)P(f), essential information regarding two distinct states is missing. Not having time, t, and not being hungry, h, is correctly computed because there is no conflict there. However, not having time, t, and being hungry, h, will result in the inference of not cooking breakfast, but that is not necessarily the case. There is still some probability that being hungry, h, will cause breakfast to be cooked even with limited or insufficient time, t.

The conflict realized, using a type-1 probability regime, of being hungry, h, and not having time, t, can be seen pretty clearly using propositional logic:

TABLE 4
Propositional Logic Contradiction Flow

| | | |
|---|---|---|
| 1 | h → b | Premise |
| 2 | ¬t → ¬b | Premise |
| 3 | h | Event |
| 4 | ¬t | Event |
| 5 | ¬h ∨ b | DeMorgan's law (1) |
| 6 | t ∨ ¬b | DeMorgan's law, double negation (2) |
| 7 | b | Disjunctive Syllogism (3), (5) |
| 8 | ¬b | Disjunctive Syllogism (4), (6) |
| 9 | b ∧ ¬b | Conjunction (7, 8) - Contradiction |

One way to help solve this issue is to assign a probability to a predicate. For example, assume that P(f)=50%. It is imagined that there are two possible evenly weighted outcomes, in one, I eat breakfast, b, and in the other, I do not eat breakfast, b. In the following example, assume the following simplified statements hold: “On any given day, I make a decision about whether to cook breakfast, b. That decision depends on a measurable independent event: (i) When I am hungry, h, the probability that I cook breakfast is proportional to what is in the fridge, f”

Table 5 shows how a type-2 probability system helps solve this issue.

TABLE 5
Type-2 Probability System Interpretation of
probability-assigned predicate example.

| | | | | | |
|---|---|---|---|---|---|
| 1 | f → b | Premise | 1 | f → b | Premise |
| 2 | ¬f → ¬b | Premise | 2 | ¬f → ¬b | Premise |
| 3 | f | Event | 3 | ¬f | Event |
| 4 | b | Hypothetical | 4 | ¬b | Hypothetical |
| | | Syllogism (1, 3) | | | Syllogism (2, 3) |

| | |
|---|---|
| World 1 | World 2 |

In a next example, consider that P(f) is based on a combination of ingredients in the fridge. For every ingredient in the fridge, the probability of eating breakfast, P(f), increases. Consider the following problem statement: “On any given day, I make a decision about whether to cook breakfast, b. That decision depends on measurable independent events: (i) If I have eggs, e, I am 50% likely to eat breakfast, b, P(e→b)=0.5; (ii) I am 50% likely to have eggs, e, P(e)=0.5.

TABLE 6
Type-2 Probability System Interpretation of problem wherein both rules and
evidence are probabilistically instantiated (single rule, non-modal logic).

| 1 | e → b | Premise | 1 | ¬(e → b) | Premise |
|---|---|---|---|---|---|
| 2 | e | Event | 2 | e | Event |
| 3 | b | Hypothetical | 3 | ¬(¬e ∨ b) | Conditional |
| | | Syllogism (1, 3) | | | Disjunction (1) |
| | Type equation here. | | 4 | e ∧ ¬b | DeMorgan (3) |
| | | | 5 | ¬b | Conjunction (4) |
| World 1 | | | World 2 | | |
| 1 | e → b | Premise | 1 | ¬(e → b) | Premise |
| 2 | ¬e | Event | 2 | ¬e | Event |
| 3 | ¬e ∨ b | Conditional | 3 | ¬(¬e ∨ b) | Conditional |
| | | Disjunction (1), b | | | Disjunction (1) |
| | | is ambiguous | | | |
| | Type equation here. | | 4 | e ∧ ¬b | DeMorgan (3) |
| | | | 5 | e ∧ ¬e | Conjunction |
| | | | | | (2, 4), |
| | | | | | contradiction |

| | |
|---|---|
| World 3 | World 4 |

Problem 1: This gives rise to inconsistent worlds where positive and negative evidence are combined. In states where b is true, the ability to include negative evidence, such as not having time, or not having ingredients without contradiction, is lost. In states where b is false, the ability to include positive evidence such as hunger, or having other ingredients without contradiction is lost.

Problem 2: If one ignores ambiguity and contradiction, the probabilities from the problem statement are no longer satisfied because that means “I always have eggs” and problem 1 is still realized.

Problem 3: If one includes ambiguity and contradiction in the probability mass, problem 1 is realized, and there is a less useful quantification of b, namely:
25% chance of b
25% chance of not b
25% chance of contradiction
25% chance of ambiguity

Consider another example, with another ingredient. Assume the problem statement: On any given day, I make a decision about whether to cook breakfast, b. That decision depends on some measurable independent events: If I have eggs, e, I am 50% likely to eat breakfast, P(e→b)=0.5; If I have yogurt, y, I am 50% likely to eat breakfast, P(y→b)=0.5; For simplicity, let's say P(e)=P(y)=1. Under this problem statement, one knows that they are 75% likely to eat breakfast, but this system of inference cannot draw that conclusion.

TABLE 7
Type-2 Probability System Interpretation of problem wherein both rules and
evidence are probabilistically instantiated (two rules, non-modal logic).

| | | | | | |
|---|---|---|---|---|---|
| 1 | e → b | Premise | 1 | ¬(e → b) | Premise |
| 2 | y → b | Event | 2 | y → b | Event |
| 3 | e ∧ y | Event | 3 | e ∧ y | Event |
| 4 | b | Hypothetical | 4 | b | Hypothetical |
| | | Syllogism (1, 3) | | | Syllogism (2, 3) |
| | | | 5 | ¬(¬e ∨ b) | Conditional |
| | | | | | Disjunction (1) |
| | | | 6 | e ∧ ¬b | DeMorgan (5) |
| | | | 7 | b ∧ ¬b | Conjunction (4, 6), |
| | | | | | Contradiction |

| | |
|---|---|
| World 1 | World 2 |

| | | | | | |
|---|---|---|---|---|---|
| 1 | e → b | Premise | 1 | ¬(e → b) | Premise |
| 2 | ¬(y → b) | Event | 2 | ¬(y → b) | Event |
| 3 | e ∧ y | Event | 3 | e ∧ y | Event |
| 4 | b | Hypothetical | 4 | ¬(¬e → b) | Conditional |
| | | Syllogism (1, 3) | | | Disjunction (1) |
| 5 | ¬(¬y ∨ b) | Conditional | 5 | ¬(¬y ∨ b) | Conditional |
| | | Disjunction (2) | | | Disjunction (2) |
| 6 | y ∧ ¬b | DeMorgan (5) | 6 | e ∧ ¬b | DeMorgan (4) |
| 7 | b ∧ ¬b | Conjunction (4, 6), | 7 | y ∧ ¬b | DeMorgan (5) |
| | | Contradiction | | | |
| | | | 8 | ¬b | Conjunction (7) |

| | |
|---|---|
| World 3 | World 4 |

Using modal logic, the problem of combining ingredients can be solved. This is shown using propositional modal logic as shown in Table 8. The problem statement for this example is the same as that associated with Table 7. Modal logic helps solve the problem because, for example, ¬(e→b) is interpreted as “I have eggs and I do not eat breakfast”, whereas the modal logic statement ¬□(e→b) is interpreted as “I cannot prove anything definitive about breakfast using the truth value of e”. The end state of ambiguity denotes a state in which neither truthhood or falsity of the event of interest (b) can be validly inferred by the rules of the system. Table 8 summarizes four worlds using modal logic and type-2 probability.

TABLE 8
Type-2 Probability System Interpretation of problem
wherein both rules and evidence are probabilistically
instantiated (two rules, modal logic).

| | | | | | |
|---|---|---|---|---|---|
| 1 | □(e → b) | Premise | 1 | ¬□(e → b) | Premise |
| 2 | □(y → b) | Event | 2 | □(y → b) | Event |
| 3 | e ∧ y | Event | 3 | e ∧ y | Event |
| 4 | b | Strict | 4 | b | Strict |
| | | Conditional (1, 3) | | | Conditional (2, 3) |

| | |
|---|---|
| World 1 | World 2 |

| | | | | | |
|---|---|---|---|---|---|
| 1 | □(e → b) | Premise | 1 | ¬□(e → b) | Premise |
| 2 | ¬□(y → b) | Event | 2 | ¬□(y → b) | Event |
| 3 | e ∧ y | Event | 3 | e ∧ y | Event |
| 4 | b | Strict | 4 | | Ambiguity |
| | | Conditional (1, 3) | | | |

| | |
|---|---|
| World 3 | World 4 |

Using modal logic satisfies the problem statements and comports with expectations. Modal logic also supports negative evidence against the event of interest and missing evidence.

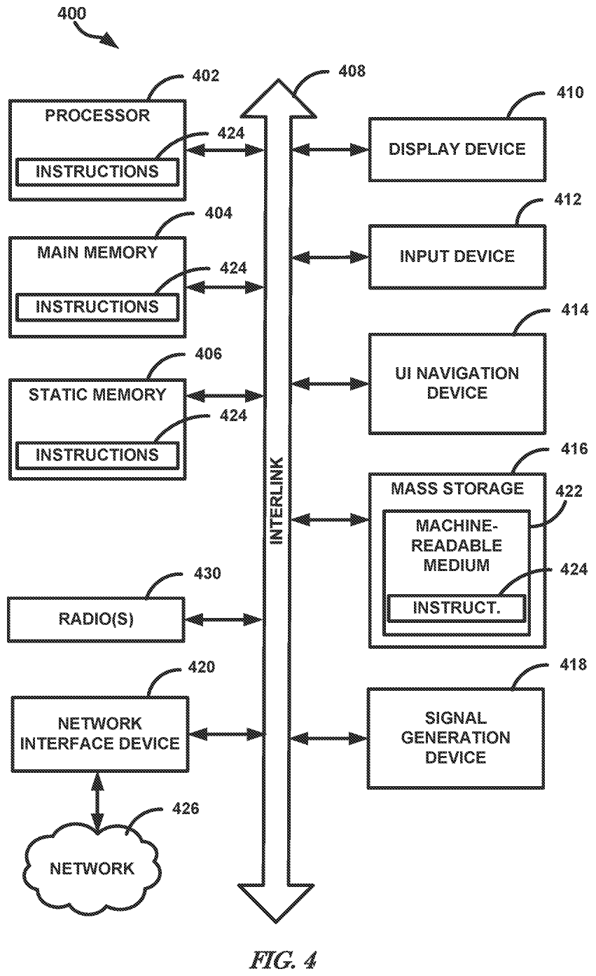

FIG. 4 illustrates, by way of example, a block diagram of an embodiment of a machine in the example form of a computer system 400 within which instructions, for causing the machine to perform any one or more of the methods discussed herein, may be executed. One or more of the input collection 102, model construction 104, inference 106, sensing system 116, model 220, or operations of the method 300, can include, or be implemented or performed by one or more of the components of the computer system 400. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a mass storage unit 416, a signal generation device 418 (e.g., a speaker), a network interface device 420, and a radio 430 such as Bluetooth, WWAN, WLAN, and NFC, permitting the application of security controls on such protocols.

The mass storage unit 416 includes a machine-readable medium 422 on which is stored one or more sets of instructions and data structures (e.g., software) 424 embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 424 may further be transmitted or received over a communications network 426 using a transmission medium. The instructions 424 may be transmitted using the network interface device 420 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### ADDITIONAL NOTES AND EXAMPLES

Example 1 includes a method comprising receiving, from one or more sensors, measurements of evidence of existence of an event of interest, providing, to a model that operates using a type-2 probability and encodes probabilistic rules provided by a subject matter expert (SME) of the event of interest, the measurements of the evidence, providing, by the model and responsive to the measurements of the evidence, an output indicating a likelihood the event of interest exists, and altering, based on a communication from the SME, an object in a geographical region of the event of interest.

In Example 2, Example I further includes, wherein the one or more sensors includes an imaging device or a weather sensor.

In Example 3, at least one of Examples 1-2 further includes receiving, from the SME and by a UI, an input indicating whether a model is to operate in permissive mode or strict mode.

In Example 4, Example 3 further includes, wherein the permissive mode operates under an assumption that the geographic region of the event of interest is consistent and the strict mode operates under an assumption that the rules are consistent.

In Example 5, at least one of Examples 1-4 further includes, wherein the output further includes respective probabilities of certain truth, certain falsity, ambiguity, and consistency.

In Example 6, at least one of Examples 1-5 further includes, wherein the output includes a single value that indicates a likelihood of existence and non-existence of the event of interest.

In Example 7, at least one of Examples 1-6, further includes receiving, from the SME of an event of interest and by a user interface (UI), probabilistic rules associating the evidence with existence of the event of interest.

In Example 8, Example 7 further includes, wherein the rules includes rules that positively associate the existence of the event of interest with first evidence and negatively associate the existence of the event of interest with second, different evidence.

Example 9 includes a non-transitory machine-readable medium including instructions that, when executed by a machine, cause the machine to perform the method of one of Examples 1-8.

Example 10 includes a system comprising processing circuitry, and a memory including instructions that, when executed by the processing circuitry, cause the processing circuitry to perform operations comprising the method of one of Examples 1-8.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instance or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving, from one or more sensors, measurements of evidence of existence of an event of interest;
providing, to a model that operates using a type-2 probability and encodes probabilistic rules, the measurements of the evidence;
providing, by the model and responsive to the measurements of the evidence, an output indicating a likelihood the event of interest exists; and
altering, based on a communication from an operator, an object in a geographical region of the event of interest.

2. The method of claim 1, wherein the one or more sensors includes an imaging device or a weather sensor; and the probabilistic rules are provided by the operator, the operator being a subject matter expert (SME) of the event of interest.

3. The method of claim 1, further comprising receiving, from the operator and by a UI, an input indicating whether a model is to operate in permissive mode or strict mode.

4. The method of claim 3, wherein the permissive mode operates under an assumption that the geographic region of the event of interest is consistent and the strict mode operates under an assumption that the rules are consistent.

5. The method of claim 1, wherein the output further includes respective probabilities of certain truth, certain falsity, ambiguity, and consistency.

6. The method of claim 1, wherein the output includes a single value that indicates a likelihood of existence and non-existence of the event of interest.

7. The method of claim 1, further comprising receiving, from the operator and by a user interface (UI), probabilistic rules associating the evidence with existence of the event of interest.

8. The method of claim 7, wherein the rules includes rules that positively associate the existence of the event of interest with first evidence and negatively associate the existence of the event of interest with second, different evidence.

9. A system comprising:
processing circuitry;
a memory including instructions that, when executed by the processing circuitry, causes the processing circuitry to perform operations comprising:
receiving, from one or more sensors, measurements of evidence of existence of an event of interest;
providing, to a model that operates using a type-2 probability and encodes probabilistic rules, the measurements of the evidence;
providing, by the model and responsive to the measurements of the evidence, an output indicating a likelihood the event of interest exists; and
altering, based on a communication from an operator, an object in a geographical region of the event of interest.

10. The system of claim 9, wherein the one or more sensors includes an imaging device or a weather sensor; and the probabilistic rules are provided by the operator, the operator being a subject matter expert (SME) of the event of interest.

11. The system of claim 9, wherein the operations further comprise receiving, from the operator and by a UI, an input indicating whether a model is to operate in permissive mode or strict mode.

12. The system of claim 11, wherein the permissive mode operates under an assumption that the geographic region of the event of interest is consistent and the strict mode operates under an assumption that the rules are consistent.

13. The system of claim 9, wherein the output further includes respective probabilities of certain truth, certain falsity, ambiguity, and consistency.

14. The system of claim 9, wherein the output includes a single value that indicates a likelihood of existence and non-existence of the event of interest.

15. The system of claim 9, further comprising receiving, from the operator and by a user interface (UI), probabilistic rules associating the evidence with existence of the event of interest.

16. The system of claim 15, wherein the rules includes rules that positively associate the existence of the event of interest with first evidence and negatively associate the existence of the event of interest with second, different evidence.

17. A non-transitory machine readable medium including instructions that, when executed by a machine, cause the machine to perform operations comprising:
receiving, from one or more sensors, measurements of evidence of existence of an event of interest;
providing, to a model that operates using a type-2 probability and encodes probabilistic rules, the measurements of the evidence;
providing, by the model and responsive to the measurements of the evidence, an output indicating a likelihood the event of interest exists; and
altering, based on a communication from an operator, an object in a geographical region of the event of interest.

18. The non-transitory machine readable medium of claim 17, wherein the one or more sensors includes an imaging device or a weather sensor; and the operator being a subject matter expert (SME) of the event of interest.

19. The non-transitory machine readable medium of claim 17, wherein the operations further comprise receiving, from the operator and by a UI, an input indicating whether a model is to operate in permissive mode or strict mode.

20. The non-transitory machine readable medium of claim 19, wherein the permissive mode operates under an assumption that the geographic region of the event of interest is consistent and the strict mode operates under an assumption that the rules are consistent.
